(19) United States
(12) Patent Application Publication
(10) Pub. No.: US 2025/0077226 A1
(43) Pub. Date: Mar. 6, 2025

(54) ASYNCRONOUS DEVELOPMENT AND COLLABORATION ENVIRONMENT

(71) Applicant: Xiaoyang Zhuang, Charlotte, NC (US)

(72) Inventor: Xiaoyang Zhuang, Charlotte, NC (US)

(21) Appl. No.: 18/240,266

(22) Filed: Aug. 30, 2023

(51) Int. Cl. G06F 8/71; G06Q 10/101

(52) U.S. Cl. CPC G06F 8/71; G06Q 10/101

(57) ABSTRACT

Methods, systems and apparatus configured to allow asynchronous project collaboration between members of a team in a development environment. The system may control versioning of the project as well as files, objects, code and other information within the project. The system may generate data lineage as well as other data governance information for any changes made to the project, files, objects, code or other information within the project.

### FIELD

The present invention relates generally to systems, tools and methods to allow for collaboration between developers and users.

### BACKGROUND

Traditional collaboration methods have been inefficient and time consuming. In the past, files and documents that are worked on by individuals, in a group or organization, needed to be consolidated by a person performing a consolidation role. The person performing the consolidation role is required to copy and paste portions of the separate files into an intermediate or final document or file. This may lead to difficulty in diagnosing bugs or issues with individual contributions.

Current collaboration methods predominantly allow users to edit and modify the same file simultaneously. This may make it extremely difficult to determine when a bug was introduced and where the issues are coming from.

### SUMMARY

The systems and methods described herein provide for the comprehensive tracking and versioning of code and data in a collaborative development environment. In some embodiments, the system and methods may be configured to generating, by a user working on a project, a package, and consuming, by the package, one or more component objects, wherein each of the one or more component objects comprises one or more component versions and wherein one of the one or more component versions may be selected for consumption. The user may request modifications of one or more of the one or more component objects. A developer may generate a new component version for each requested component object modification. The new component versions of the component objects may then be validated against the package of the requesting user. Each component object may be updated with their corresponding new component version and each updated component object may be saved to a versioning database. Each of the one or more updated component objects may be deployed. The consumption of the one or more updated component objects may be elective.

In some embodiments, one or more of the one or more updated component objects may be consumed by one or more other packages and each of the one or more other packages may consume an older component version of the updated component objects.

In some embodiments, one or more of the one or more other packages may be updated to select, for consumption, the new component version of the one or more updated component objects.

In some embodiments, the new versions of the one or more updated component objects may not been validated against one or more of the one or more other packages.

In some embodiments, a usage metric may be tracked for each of the one or more component objects, wherein the usage metric may comprise usage information for each of the one or more component versions of the corresponding component object.

In some embodiments, the new component version of one or more of the updated component objects may be executed by the requesting user.

In some embodiments, one or more code objects may be stored in a versioning database. Each code object may comprise one or more code versions. One or more data objects may be stored in the versioning database, wherein each data object may comprise one or more data versions, wherein each data version may comprise a data lineage and a dependency tree, and wherein the data lineage and the dependency tree of each data version may comprise information corresponding to a code version of each code object and a data version of each data object used to generate each respective data version.

In some embodiments, the collaborative development environment may further be configured for receiving, from a user, a selection of two or more data versions of a first data object or two or more code versions of a first code object. The system may identify, between the two or more selected data versions or the two or more selected code versions, resulting changes to one or more data objects and one or more code objects, and visually display said changes to the user. The system may then further identify, between the two or more selected data versions or the two or more selected code versions, a magnitude of impact for each selected data version or each selected code version.

In some embodiments, a usage metric may be tracked for each of the one or more data objects, wherein the usage metric may comprise usage information for each of the one or more data versions of the corresponding data object.

In some embodiments, for any data object run by the user, the user may select a data version to be run. The selection may comprise selecting, through a user interface, an interface element corresponding to the data version to be run or specifying, via code, the data version to be run.

In some embodiments, each data version of a data object and each code version of a code object may be selectable, by the user, for consumption. When a new version of a data object or a code object is selected by the user, one or more pieces of code may be identified as needing to be re-run based on the dependency tree of the new version.

In some embodiments, each data object and code object further may comprise statistics including an identity of one or more consuming users, frequency of consumption, acceptance/rejection by users and notes corresponding to the acceptance/rejection by users.

In some embodiments, the system and methods may provide for asynchronous development, tracking and governance of code. In some embodiments, the system may be configured to manage code and data versioning. The system may include one or more servers, one or more client devices, one or more developer devices and one or more consolidating devices. The one or more client devices may be operated by one or more users. The one or more developer devices may be operated by or one or more developers.

In some embodiments, the consolidating devices may be the same or similar to the client devices and/or the developer devices. The consolidating devices may be operated by one or more users and/or one or more developers.

In some embodiments, the server may be configured to receive, from the one or more developer devices, one or more shared functions. The one or more shared functions may be generated by the one or more developers. Each of the one or more shared functions may be associated with one or more versions. The system may further be configured to receive, from the one or more client devices, one or more source data objects, wherein the one or more source data objects may be stored in a project data bucket of a project.

In some embodiments, the server may receive, from the one or more client devices, one or more project code blocks for the project. The one or more project code blocks may comprise function calls to the one or more shared functions. The one or more project code blocks may correspond to instructions to be executed by the server. In some embodiments, the instructions may be configured to generate one or more target data objects based on the one more shared functions and the one or more source data objects stored in the project data bucket.

In some embodiments, the system may be configured to generate, by the server, a data governance object for the project. The data governance object may comprise data lineage of the project. The data lineage may define an association between the one or more generated target data objects, the one or more source data objects, the one or more project code blocks and a version of each shared functions called from the one or more project code blocks.

In some embodiments, the system may further be configured to receive, from a first developer device operated by a first developer, a first update for a first shared function. The first update may correspond to a new version of the first shared function. An indication that the first shared function has been updated may be displayed to a first user operating a first client device. The first user may select the new version of the first shared function from a list of versions of the first shared function. The server may then perform a new execution of a first project code block using the new version of the first shared function. In some embodiments, the system may generate, for the new execution of the first project code block, one or more new target data objects and a new data governance object.

In some embodiments, the system may be configured to receive, from the first user, an indication of acceptance or rejection of the new version of the first shared function. If a rejection indication is received, the system may revert the first shared function used in the first project code block to a first previous version of the first shared function. The reverting may comprise receiving a selection of the first previous version from a list of one or more previous versions of the first shared function and re-executing the first project code block.

In some embodiments, the system may further be configured to display the one or more shared functions in an editable window. Each of the one or more version of the one or more shared functions may also display a quality metric associated with the version. The quality metric may comprise the display of a count of users that indicated acceptance and a count of users that indicated rejection of the version.

In some embodiments, a first project code block of the one or more project code blocks may be published by a first user. Publishing may further comprise generating a new shared function corresponding to the first project code block and providing the new shared function to the one or more client devices and the one or more developer devices.

In some embodiments, the system may further be configured for accessing, by a consolidator user operating on a consolidating device, the project, the project data bucket, the one or more shared functions and the new shared function. An updated execution of the project using the new shared object may be initialized by the consolidator user. The results of the updated execution may then be evaluated by the consolidator user. Evaluating may comprise performing comparisons between the results of the updated execution and a previous execution of the project.

The features and components of these embodiments will be described in further detail in the description which follows. Additional features and advantages will also be set forth in the description which follows, and in part will be implicit from the description, or may be learned by the practice of the embodiments. The detailed description and specific examples are intended for illustration only and are not intended to limit the scope of the disclosure.

### BRIEF DESCRIPTION OF THE DRAWINGS

The present disclosure will become better understood from the detailed description and the drawings, wherein:

FIG. 1 is a diagram illustrating an exemplary development and collaboration environment in which some embodiments may operate.

FIG. 2A is a diagram illustrating an exemplary developer device in accordance with aspects of the present disclosure.

FIG. 2B is a diagram illustrating an exemplary user device in accordance with aspects of the present disclosure.

FIG. 2C is a diagram illustrating an exemplary server in accordance with aspects of the present disclosure.

FIG. 3A is an exemplary user interface in accordance with aspects of the present disclosure.

FIG. 3B is an exemplary user interface in accordance with aspects of the present disclosure.

FIG. 3C is an exemplary user interface in accordance with aspects of the present disclosure.

FIG. 3D is an exemplary user interface in accordance with aspects of the present disclosure.

FIG. 3E is an exemplary user interface in accordance with aspects of the present disclosure.

FIG. 3F is an exemplary user interface in accordance with aspects of the present disclosure.

FIG. 3G is an exemplary user interface in accordance with aspects of the present disclosure.

FIG. 3H is an exemplary user interface in accordance with aspects of the present disclosure.

FIG. 3I is an exemplary user interface in accordance with aspects of the present disclosure.

FIG. 3J is an exemplary user interface in accordance with aspects of the present disclosure.

FIG. 3K is an exemplary user interface in accordance with aspects of the present disclosure.

FIG. 4A is an exemplary spreadsheet generated by the user interface in accordance with aspects of the present disclosure.

FIG. 4B is an exemplary spreadsheet generated by the user interface in accordance with aspects of the present disclosure.

FIG. 4C is an exemplary spreadsheet generated by the user interface in accordance with aspects of the present disclosure.

FIG. 5A is a flow chart illustrating an exemplary method that may be performed in accordance with some embodiments.

FIG. 5B is a flow chart illustrating an exemplary method that may be performed in accordance with some embodiments.

FIG. 5C is a flow chart illustrating an exemplary method that may be performed in accordance with some embodiments.

FIG. 6 is a diagram illustrating an exemplary computer/control system that may perform processing in some embodiments and in accordance with aspects of the present disclosure.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

The following generally relates to a system and methods to allow for asynchronous collaboration between a plurality of users, developers and consolidators. In some embodiments, the system may be configured to allow one or more teams to collaborate with one another. The system may allow for each member of a team to individually draft or develop work products, including files, objects, code blocks or other information. Each member may then publish their work products in an asynchronous fashion to a server or datastore for evaluation and use by other team members.

In some embodiments, a consolidator user may be provided with a consolidating interface on a consolidating device. Through said interface, the consolidator user may test and evaluate newly published work products from team members. Testing may include incorporating newly published work products with previously published work products in a project to determine proper functionality.

In some embodiments, the system may be configured to perform data cleaning, munging and preprocessing as well produce visualizations and other outputs for user consumption.

In some embodiments, developers and/or users may create projects and/or associate themselves with a previously created project. The term “users” may be used in place of developers and consolidators, and should be considered to include developers, consolidators and users when used in this document.

The user may upload information, data, objects and/or files into a data bucket associated with the project. This data bucket may contain some or all of the data in which the project operates on. In some embodiments, the data bucket may include information, data, objects and/or files retrieved from remote sources, such as databases and network attached storage devices.

In some embodiments, the user may add/insert code blocks or scripts into the project. The scripts may be validated before being executed by the system. The scripts may reference one or more shared functions that are stored in the system. The one or more shared functions may be functions that have been previously written, validated, published and tested by other users. The user may choose to publish their created scripts so as to allow their scripts to be tested and shared with other team members.

After each edit of the user created scripts, the script may be validated before execution. In some embodiments, the execution of the scripts may result in the generation of one or more target data objects. Target data objects may include spreadsheets, equations, data cells, metadata or files for consumption as an intermediate product or a final product.

In some embodiments, developers may publish shared functions that may be tested by other users. The other users may accept or reject any shared function that they test. This feedback may be used to determine a quality metric for each of the shared functions.

In some embodiments, users may be notified when an update is available for a function that they have used in a script or code block. Updated shared functions may also be visually differentiated from shared functions without an updated version. In some embodiments, the user may select a shared function and be provided with a list of different versions of the selected shared function. Each version of the shared function may include a user rating or quality metric, and these ratings/metrics may be displayed along with other information relating to the version. The user may then run their script with the selected version of the shared function.

In some embodiments, an indication of each shared function used in a script may be displayed to the user as a shared function indicator. The shared function indicators may also allow a user to change which version of a shared function to use while running their script.

In some embodiments, the generated target data objects may be modified when different versions of the shared functions are used.

In some embodiments, changes to the data bucket information may cause additional information to be generated in the target data objects. Changes to the target data objects themselves may trigger the generation of additional data items within the target data object. For example, the target data object may be a spreadsheet, and changing a data field within the spreadsheet may generate additional data fields, rows, columns, categories and/or cells. The target data object may be a dynamic object that can be modified through the script that is used to create it, as well as through modifications of portions of the target data object itself.

With regard to spreadsheet data objects, modifications to a first data item of the target data object may initiate a change in one or more additional data items of the target data object. Adding a second data item to the target data object may cause the generation of one or more additional data items within the target data object. Removing a third data item from the target data object may cause a modification or removal of one or more additional data items from the target data object.

In some embodiments, the target data object may include a specification, formulas, functions, external references, internal references and/or other functionality to generate dynamic data items within the target data object.

In some embodiments, the target data object may be configured to consume information/data from the projects data bucket. The individual data items of the target data object may correspond to the data bucket that it is linked to. In some embodiments, different data buckets may be linked to a target data object to generate different data items within the object. For example, if the target data object is a spreadsheet, the number of columns, number of rows and categories, titles, and values of individual cells may be generated based on the data bucket that it is linked to.

In some embodiments, the system may be configured to generate one or more data governance objects for a project. In some embodiments, a single data governance object may be created for a project. Data governance objects may be generated for each modification to a project. In some embodiments, each data governance object may include data lineage of each shared function, data bucket, target data object and each script run by the users (data objects). In some embodiments, some or all of the data objects may be stored on in a versioning database. An object for piece of data Each of the stored data objects may comprise one or more data versions and data lineage associated with each of the one or more data versions. In some embodiments a dependency tree may be generated for some or all of the data objects. The data lineage and dependency tree for the data object and data versions may be updated each time the data object is modified and/or executed.

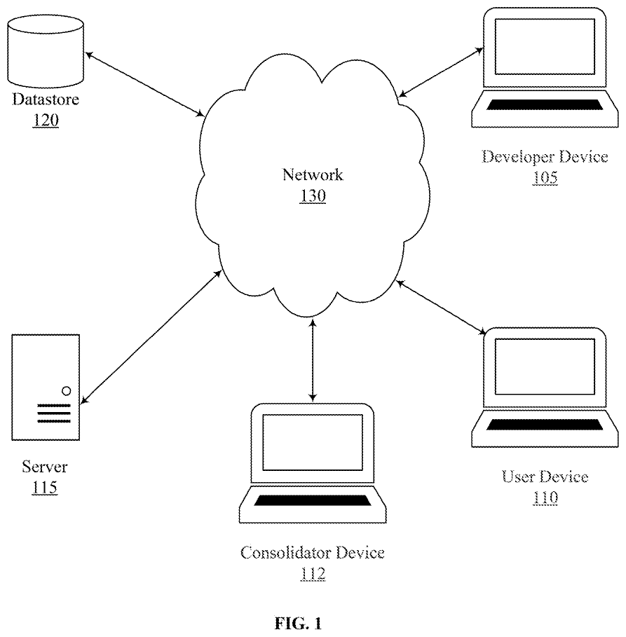

FIG. 1 is a diagram illustrating an exemplary development and collaboration environment 100 in which some embodiments may operate. The development and collaboration environment 100 may comprise one or more developer devices 105, one or more user devices 110, one or more consolidator devices 112, one or more servers 115, one or more datastores 120 and one or more networks 130.

The developer devices 105 may be any computing device capable of communicating over network 130. The developer devices 105 may be integrated into a notebook computer, smartphone, personal digital assistant, desktop computer, tablet computer, or other computing device.

The user devices 110 may be any computing device capable of communicating over network 130. The user devices 110 may be integrated into a notebook computer, smartphone, personal digital assistant, desktop computer, tablet computer, or other computing device.

The developer devices 105, user devices 110 and consolidator devices 112 may be the same or similar devices. The consolidator devices 112 may be operated by consolidation users. The consolidation users may be developers, business users, or any other user with access to the development environment and projects within the development system.

Server 115 may be one or more physical or virtual machines configured to communicate with the one or more developer devices 105, user devices 110, consolidator devices 112 and datastores 120. The one or more servers may be configured as a distributed computing infrastructure and processing of applications and other software may be carried out on the cloud.

Datastores 120 may communicate with one another over network 130. Datastores 120 may be any storage device capable of storing data for processing or as a result of processing information at the developer devices 105, user devices 110, consolidator devices 112 and/or servers 115. The datastores 120 may be a separate device or the same device as server 115. The datastore 120 may be located in the same location as that of server 115, or at separate locations.

Network 130 may be an intranet, internet, mesh, LTE, GSM, peer-to-peer or other communication network that allows the one or more servers 115 to communicate with the one or more developer devices 105, user devices 110, consolidator devices 112 and datastores 120.

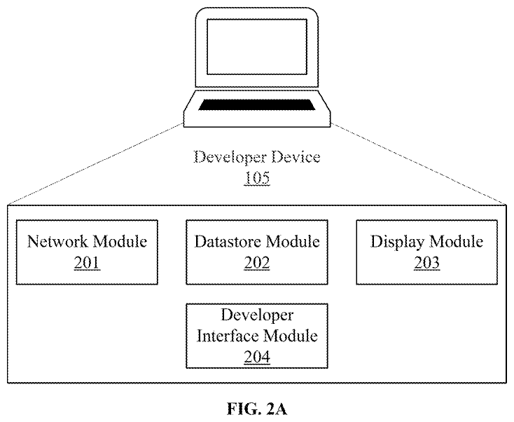

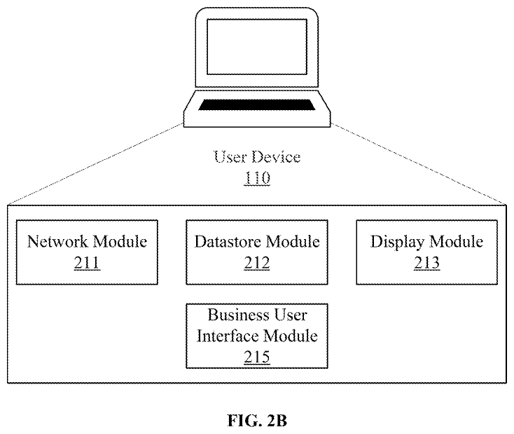

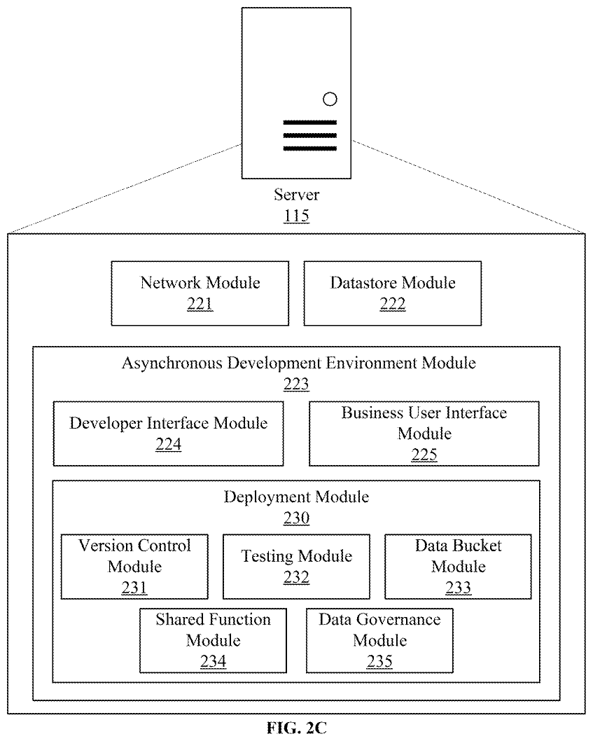

FIG. 2A is a diagram illustrating an exemplary developer device 105 in accordance with aspects of the present disclosure. Developer device 105 may comprise network module 201, datastore module 202, display module 203 and developer interface module 204. Network module 201 may transmit and receive data from other computing systems via a network. In some embodiments, the network module 201 may enable transmitting and receiving data from the Internet. Data received by the network module 201 may be used by the other modules. The modules may transmit data through the network module 201.

The datastore module 202 may be configured to store information and data used in the operation of the system. Information generated by the operation of the system may also be stored in the datastore module.

Display module 203 may be any device configured to display graphical representations of information (LCD display, OLED display, DLP display, etc.).

Developer interface module 204 may be configured to allow a developer to upload information, data, objects and/or files into a data bucket associated with a project, test and publish code blocks, create shared functions and modify and/or remove shared functions.

FIG. 2B is a diagram illustrating an exemplary user device 110 in accordance with aspects of the present disclosure. User device 110 may comprise network module 211, datastore module 212, display module 213 and business user interface module 215.

Network module 211, datastore module 212 and display module 213 may be the same or similar to that of network module 201, datastore module 202 and display module 203 of FIG. 2A and will not be described for the sake of brevity.

Business user interface module 215 may be configured to allow a user to add code blocks to a project, select shared function versions to be used by the code block, upload information, data, objects and/or files into a data bucket associated with the project and generate target data objects.

FIG. 2C is a diagram illustrating an exemplary server 115 in accordance with aspects of the present disclosure. Server 115 may comprise network module 221, datastore module 222 and asynchronous development environment module 223.

Network module 221 and datastore module 222 may be the same or similar to that of network module 201 and datastore module 202 in FIG. 2A.

Asynchronous development environment module 223 may comprise developer interface module 224, business user interface module 225 and deployment module 230.

Developer interface module 224 may be the same or similar to that of developer interface module 204 of FIG. 2A.

Business user interface module 225 may be the same or similar to that of business user interface module 205 of FIG. 2B.

Deployment module 230 may comprise version control module 231, testing module 232, data bucket module 233, shared function module 234 and data governance module 235.

Version control module 231 may be configured to maintain a log of changes made to projects, shared functions, data buckets and target data objects. Version control module 231 may also be configured to manage and store one or more versions of projects, shared functions, data buckets and target data objects corresponding to any changes, additions, deletions or other modifications to the projects, shared functions, data buckets and target data objects.

Testing module 232 may be configured to perform one or more evaluations of the one or more shared functions, versions of the one or more shared functions and published code blocks from users. Evaluations may be performed for different combinations of the published code blocks, shared function versions and linked data buckets.

Data bucket module 233 may be configured to store one or more data buckets for each project. Each data bucket may include data items such as information, data, objects and/or files that are to be used by the project.

Shared function module 234 may be configured to store one or more shared functions for a project. The shared function module 234 may further be configured to receive new shared functions from users, modifications of stored shared functions and removal shared functions.

Data governance module 235 may be configured to generate data governance objects. The data governance objects may comprise data lineage information related to a project. The data lineage may be used to define an association between generated target data objects, source data objects, project code blocks and a version of each shared functions called from the project code blocks. The data governance module 235 may further be configured to generate data lineage and dependency trees for each object.

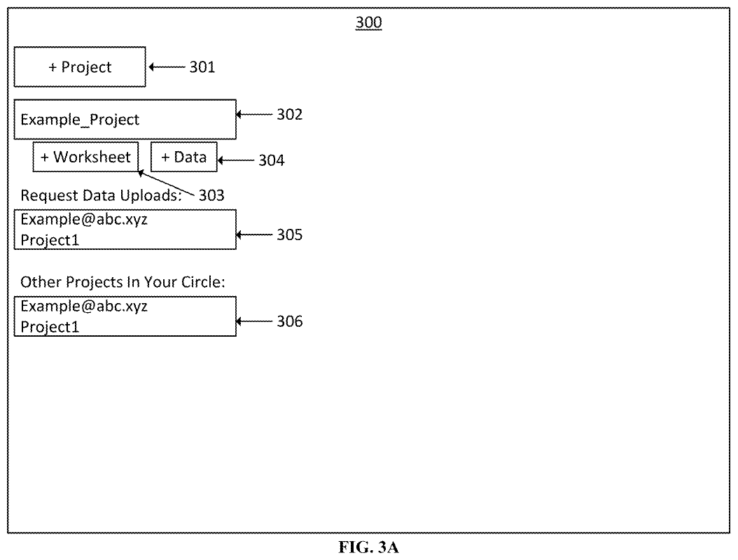

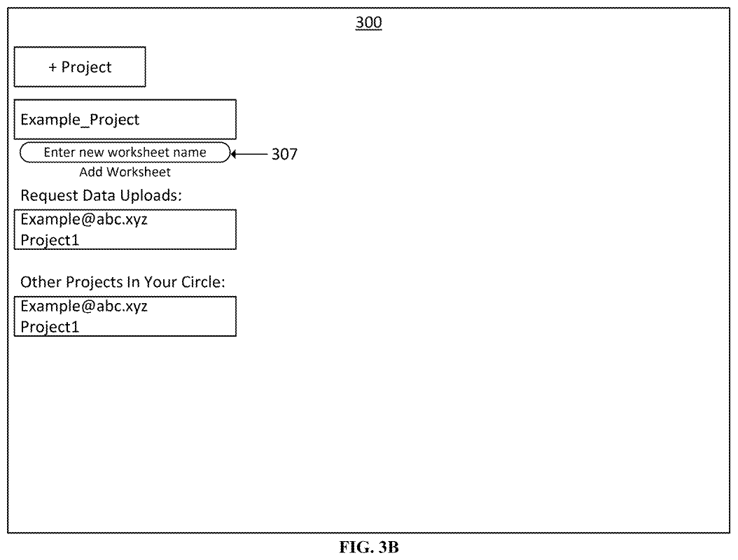

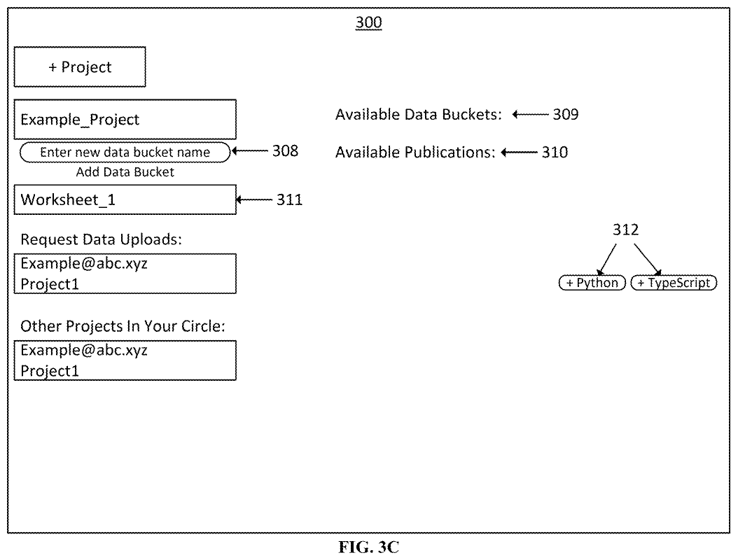

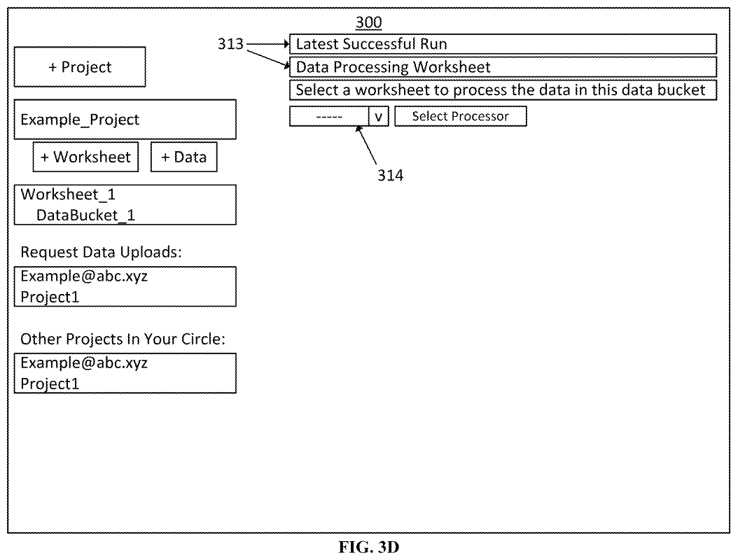

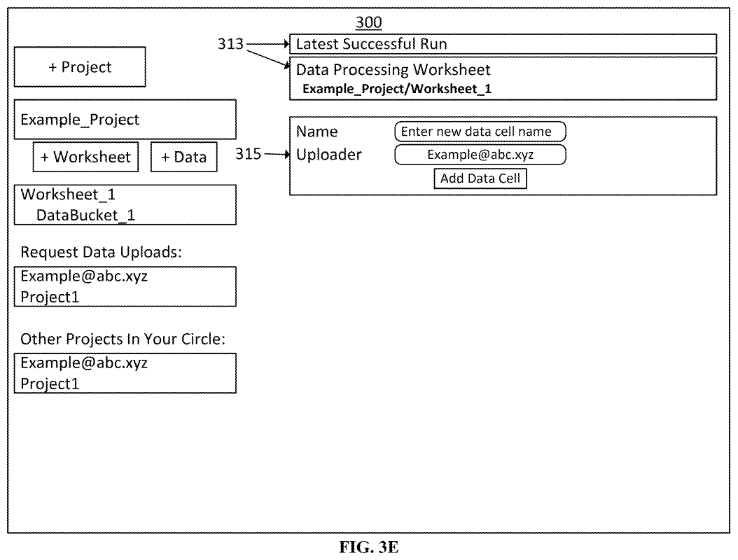

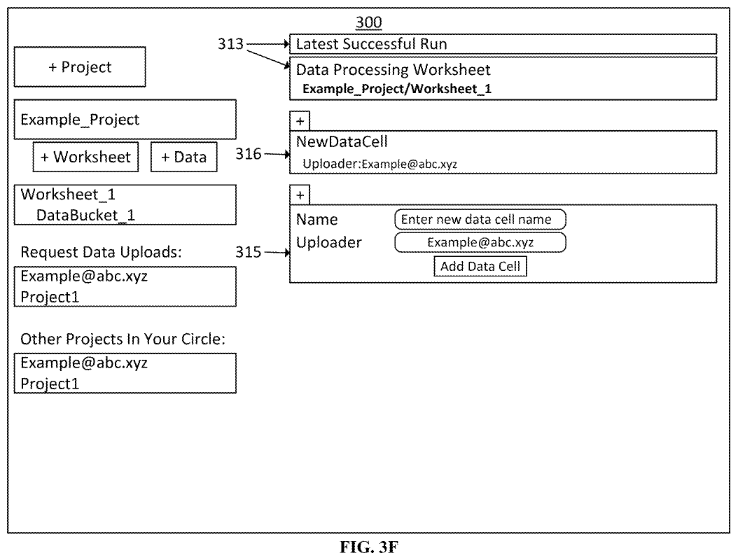

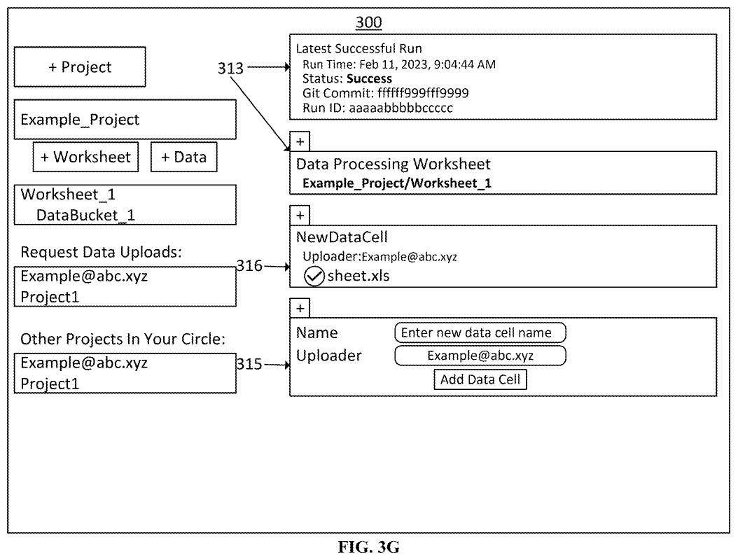

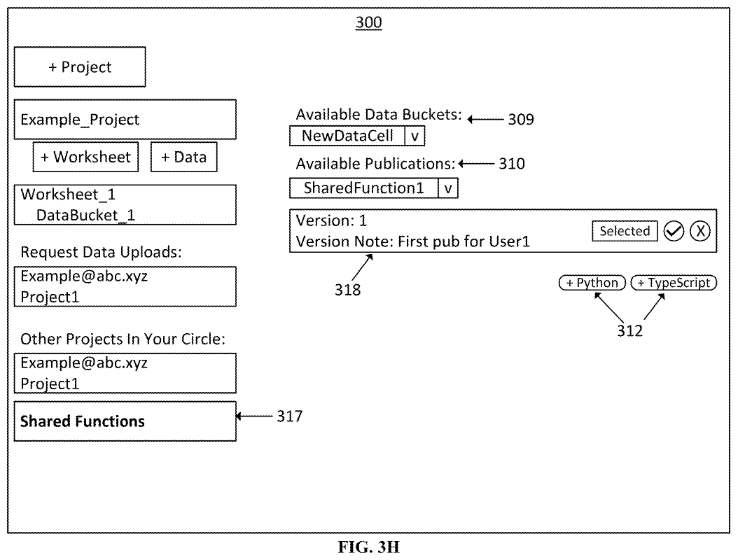

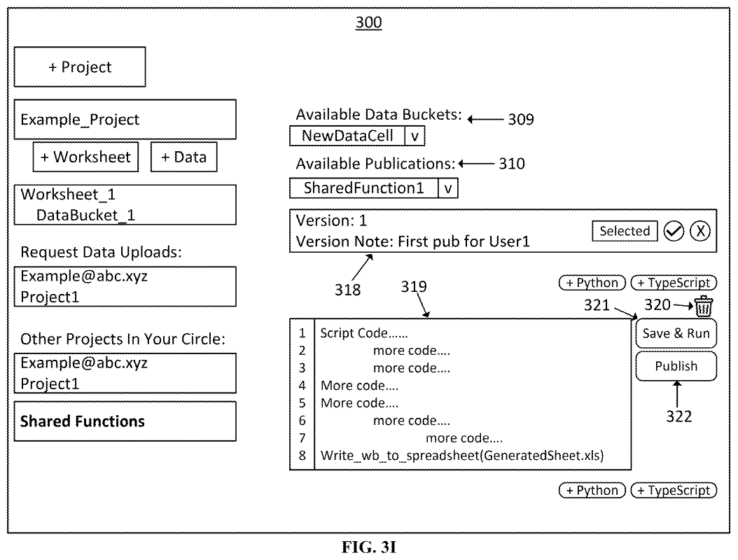

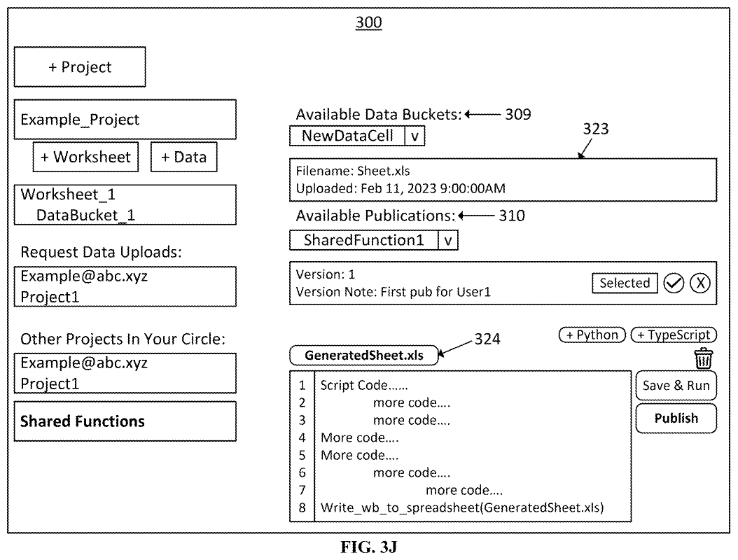

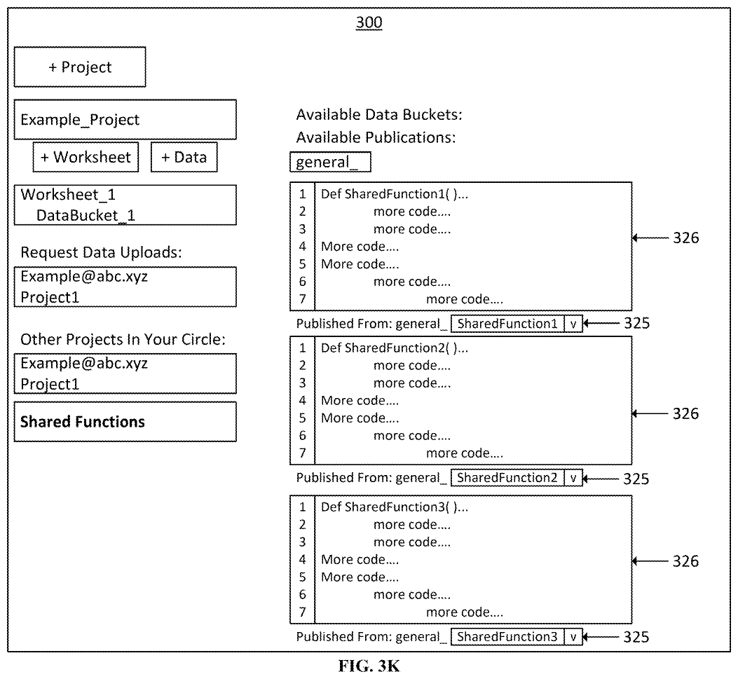

FIGS. 3A-3K are an exemplary development and collaboration user interface (UI) 300 in accordance with aspects of the present disclosure. FIG. 3A shows the UI 300 comprising a new project button 301, current project name 302, add worksheet button 303, add data button 304, requested uploads 305 and project listing 306. A user may choose to create a new project by selecting the new project button 301. The user may add a worksheet and data to the project by selecting the add worksheet button 303 and add data button 304.

In FIG. 3B, after a user selection of the new worksheet button 303, the user is prompted to enter a worksheet name into the new worksheet name input 307.

FIG. 3C shows the display of the new data bucket name input 308 corresponding to the selection of add data button 304 from FIG. 3A. UI 300 may be configured to show information relating to the available data buckets 309 and available publications 310. Current worksheet 311 shows the worksheet name of the worksheet that was added in FIG. 3B.

The user may select the add script buttons 312. Selection of the add script buttons may generate a new code block/script object and provide an editing pane for the user to enter their code/script.

FIG. 3D shows processing information 313 and a worksheet selector 314. FIG. 3F shows a cell addition frame 315, wherein the user may create a new data cell 316 for the worksheet.

FIG. 3G shows the processing information 313 after the addition of the new data cell 316 and the processing of the worksheet. New data cell 316 also shows a generated file object “sheets.xls” that is generated as a result of the processing of the worksheet.

FIG. 3H shows a list of available data buckets 309 and available publications 310 that are associated with the project and worksheet. The available publications 310 may correspond to one or more shared functions. Function version information 318 for the one or more shared functions may be shown. Shared function button 317 may be selected to navigate to a shared function pane.

FIG. 3I shows a project script 319 that has been created/added by a user. The user may choose to delete 320, save & run 321 or publish 322 the project script. Selecting save & run 321 may save the project script and initiate a validation operation before the project script is executed. After the project script 319 has been saved, validated and run, the user may choose to publish said project script. Publishing the project script 319 may result in the sharing of the script with other users and/or the generation of a shared function that can then be used by other users. Published project scripts may also be tested and evaluated by a consolidator or other users.

Data bucket information 323 may be displayed after running of the project script 316. Execution of project script 316 may create one or more generated documents 324. Generated documents 324 may correspond to one or more target data objects.

FIG. 3K shows a shared function pane. The shared function pain displays shared function identification 325 of one or more shared functions. Shared function code pane 326 displays the code for the corresponding shared function. In some embodiments, the shared function code pane 326 may be an editable pane, where the user may make modifications to the one or more shared functions displayed.

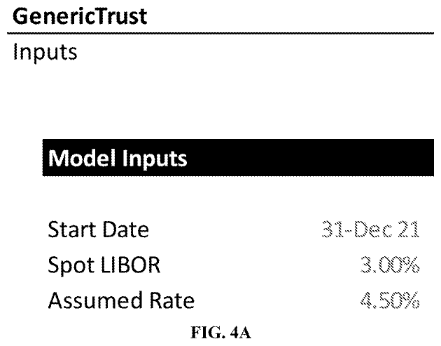

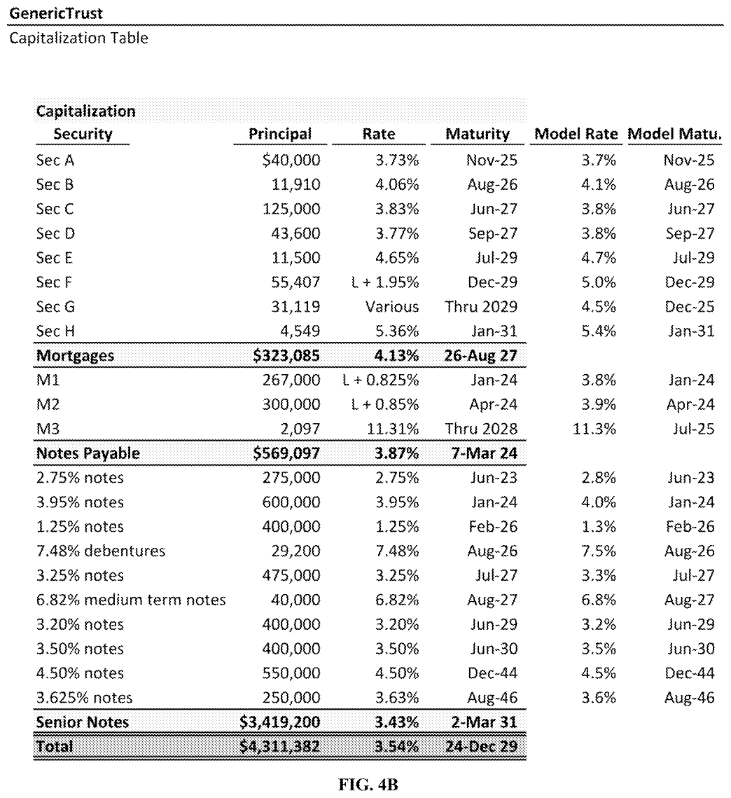

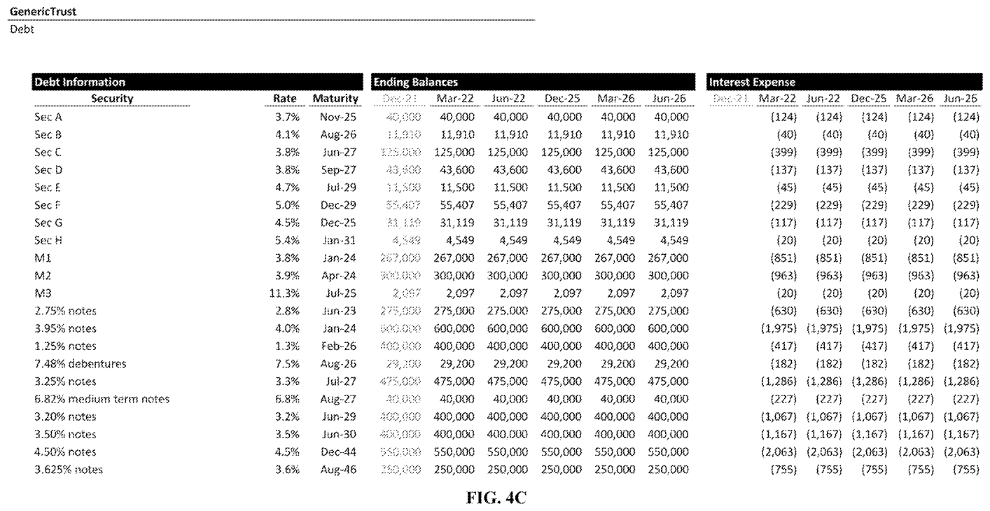

FIG. 4A shows an example of data bucket information 400 that may be used by a project script to create one or more target data objects, including one or more generated documents. FIGS. 4B and 4C are examples of generated documents 410 and 420 created by the execution of a project script. The execution may use one or more fields of the data bucket information 400 to create the generated documents 410 and 420. In some embodiments, fields from the data bucket information 400 may be used to modify and/or add fields, columns or rows to the generated documents 410 and 420.

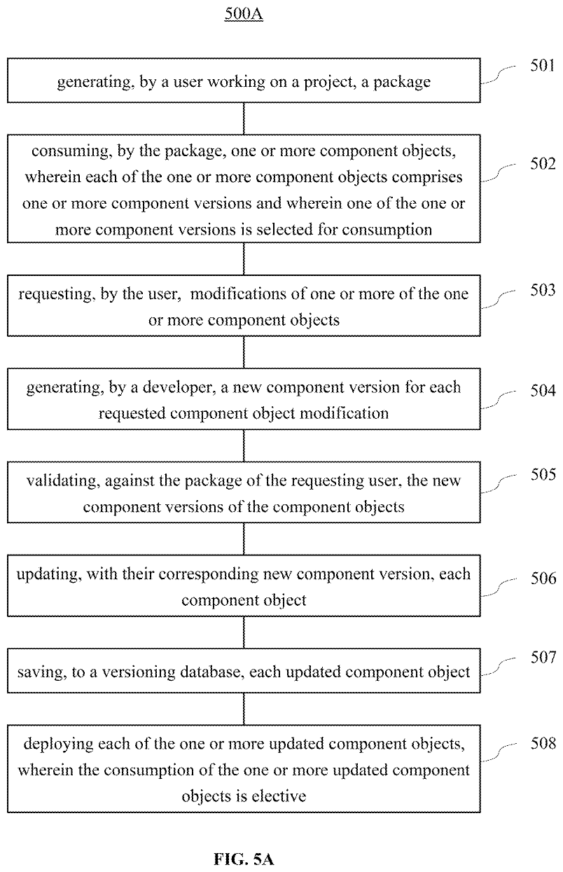

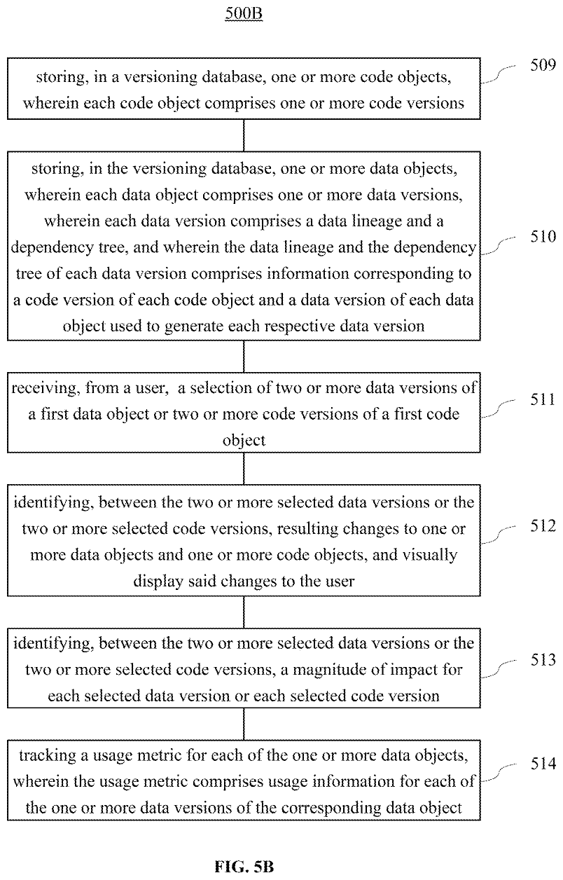

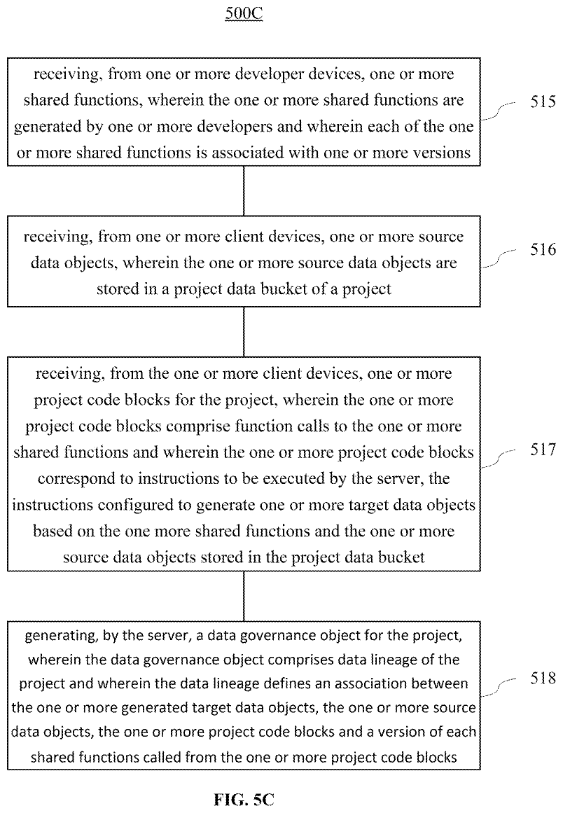

FIG. 5A is a flow chart illustrating an exemplary method 500 that may be performed in accordance with some embodiments.

At step 501, the system is configured to generate, by a user working on a project, a package.

At step 502, the system is configured to consume, by the package, one or more component objects, wherein each of the one or more component objects comprises one or more component versions and wherein one of the one or more component versions is selected for consumption.

At step 503, the system is configured to request, by the user, modifications of one or more of the one or more component objects.

At step 504, the system is configured to generate, by a developer, a new component version for each requested component object modification.

At step 505, the system is configured to validate, against the package of the requesting user, the new component versions of the component objects.

At step 506, the system is configured to update, with their corresponding new component version, each component object.

At step 507, the system is configured to save, to a versioning database, each updated component object.

At step 508, the system is configured to deploy each of the one or more updated component objects, wherein the consumption of the one or more updated component objects is elective.

FIG. 5B is a flow chart illustrating an exemplary method 500B that may be performed in accordance with some embodiments.

At step 509, the system is configured to store, in a versioning database, one or more code objects, wherein each code object comprises one or more code versions.

At step 510, the system is configured to store, in the versioning database, one or more data objects, wherein each data object comprises one or more data versions, wherein each data version comprises a data lineage and a dependency tree, and wherein the data lineage and the dependency tree of each data version comprises information corresponding to a code version of each code object and a data version of each data object used to generate each respective data version.

At step 511, the system is configured to receive, from a user, a selection of two or more data versions of a first data object or two or more code versions of a first code object.

At step 512, the system is configured to identify, between the two or more selected data versions or the two or more selected code versions, resulting changes to one or more data objects and one or more code objects, and visually display said changes to the user.

At step 513, the system is configured to identify, between the two or more selected data versions or the two or more selected code versions, a magnitude of impact for each selected data version or each selected code version.

At step 514, the system is configured to track a usage metric for each of the one or more data objects, wherein the usage metric comprises usage information for each of the one or more data versions of the corresponding data object.

FIG. 5C is a flow chart illustrating an exemplary method 500C that may be performed in accordance with some embodiments.

At step 515, the system is configured to receive, from one or more developer devices, one or more shared functions, wherein the one or more shared functions are generated by one or more developers and wherein each of the one or more shared functions is associated with one or more versions.

At step 516, the system is configured to receive, from one or more client devices, one or more source data objects, wherein the one or more source data objects are stored in a project data bucket of a project.

At step 517, the system is configured to receive, from the one or more client devices, one or more project code blocks for the project, wherein the one or more project code blocks comprise function calls to the one or more shared functions and wherein the one or more project code blocks correspond to instructions to be executed by the server, the instructions configured to generate one or more target data objects based on the one more shared functions and the one or more source data objects stored in the project data bucket.

At step 518, the system is configured to generate, by the server, a data governance object for the project, wherein the data governance object comprises data lineage of the project and wherein the data lineage defines an association between the one or more generated target data objects, the one or more source data objects, the one or more project code blocks and a version of each shared functions called from the one or more project code blocks.

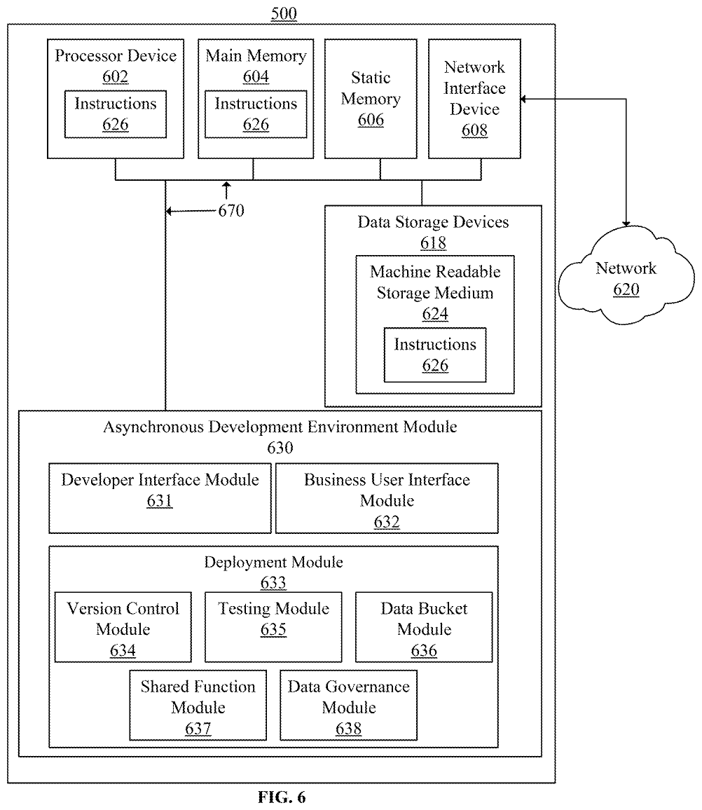

FIG. 6 illustrates an example machine of a computer system within which a set of instructions, for causing the machine to perform any one or more of the methodologies discussed herein, may be executed. In alternative implementations, the machine may be connected (e.g., networked) to other machines in a LAN, an intranet, an extranet, an ad-hoc network, a mesh network, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage device 618, which communicate with each other via a bus 660.

Processing device 602 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein.

The computer system 600 may further include a network interface device 608 to communicate over the network 620. The computer system 600 also may include asynchronous development environment module 630. Asynchronous development environment module 630 may further comprise developer interface module 631, business user interface module 632 and deployment module 633. Deployment module 633 may further comprise version control module 634, testing module 365, data bucket module 636, shared function module 637 and data governance module 638.

Asynchronous development environment module 630, developer interface module 631, business user interface module 632, deployment module 633, version control module 634, testing module 365, data bucket module 636, shared function module 637 and data governance module 638 may be the same or similar to that of the asynchronous development environment module 223, developer interface module 224, business user interface module 225, deployment module 230, version control module 231, testing module 232, data bucket module 233, shared function module 234 and data governance module 235 disclosed in FIG. 2C.

The data storage device 618 may include a machine-readable storage medium 624 (also known as a computer-readable medium) on which is stored one or more sets of instructions or software 626 embodying any one or more of the methodologies or functions described herein. The instructions 626 may also reside, completely or at least partially, within the main memory 604 and/or within the processing device 602 during execution thereof by the computer system 600, the main memory 604 and the processing device 602 also constituting machine-readable storage media. Information, including data used in the processes and methods of the system and the one or more sets of instructions or software, may also be stored in blockchain, as NFTs or other decentralized technologies.

In one implementation, the instructions 626 include instructions to implement functionality corresponding to the components of a device to perform the disclosure herein. While the machine-readable storage medium 624 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

It will be appreciated that the present disclosure may include any one and up to all of the following examples.
Example 1. A method to comprehensively track and version code and data in a collaborative development environment, the method comprising: generating, by a user working on a project, a package; consuming, by the package, one or more component objects, wherein each of the one or more component objects comprises one or more component versions and wherein one of the one or more component versions is selected for consumption; requesting, by the user, modifications of one or more of the one or more component objects; generating, by a developer, a new component version for each requested component object modification; validating, against the package of the requesting user, the new component versions of the component objects; updating, with their corresponding new component version, each component object; saving, to a versioning database, each updated component object; and deploying each of the one or more updated component objects, wherein the consumption of the one or more updated component objects is elective.
Example 2. The method of Example 1, wherein one or more of the one or more updated component objects are consumed by one or more other packages; and wherein each of the one or more other packages consume an older component version of the updated component objects.
Example 3. The method of any one of Examples 1-2, wherein one or more of the one or more other packages are updated to select, for consumption, the new component version of the one or more updated component objects.
Example 4. The method of any one of Examples 1-3, wherein the new versions of the one or more updated component objects has not been validated against one or more of the one or more other packages.
Example 5. The method of any one of Examples 1-4, wherein, a usage metric is tracked for each of the one or more component objects, wherein the usage metric comprises usage information for each of the one or more component versions of the corresponding component object.
Example 6. The method of any one of Examples 1-5, wherein the new component version of one or more of the updated component objects is executed by the requesting user.
Example 7. A method to comprehensively track and version code and data in a collaborative development environment, the method comprising: storing, in a versioning database, one or more code objects, wherein each code object comprises one or more code versions; storing, in the versioning database, one or more data objects, wherein each data object comprises one or more data versions, wherein each data version comprises a data lineage and a dependency tree, and wherein the data lineage and the dependency tree of each data version comprises information corresponding to a code version of each code object and a data version of each data object used to generate each respective data version.
Example 8. The method of Example 7, wherein the collaborative development environment is further configured for: receiving, from a user, a selection of two or more data versions of a first data object or two or more code versions of a first code object; identifying, between the two or more selected data versions or the two or more selected code versions, resulting changes to one or more data objects and one or more code objects, and visually display said changes to the user; and identifying, between the two or more selected data versions or the two or more selected code versions, a magnitude of impact for each selected data version or each selected code version.
Example 9. The method of any one of Examples 7-8, wherein, a usage metric is tracked for each of the one or more data objects, wherein the usage metric comprises usage information for each of the one or more data versions of the corresponding data object.
Example 10. The method of any one of Examples 7-9, wherein, for any data object run by the user, the user selects a data version to be run, and wherein the selection comprises: selecting, through a user interface, an interface element corresponding to the data version to be run; or specifying, via code, the data version to be run.
Example 11. The method of any one of Examples 7-10, wherein, each data version of a data object and each code version of a code object is selectable, by the user, for consumption; and wherein, when a new version of a data object or a code object is selected by the user, one or more pieces of code are identified as needing to be re-run based on the dependency tree of the new version.
Example 12. The method of any one of Examples 7-11, wherein, a usage metric is tracked for each of the one or more data objects, wherein the usage metric comprises usage information for each of the one or more data versions of the corresponding data object.
Example 13. The method of any one of Examples 7-12, wherein each data object and code object further comprises: statistics including an identity of one or more consuming users; frequency of consumption; acceptance/rejection by users; and notes corresponding to the acceptance/rejection by users.
Example 14. A system for comprehensively tracking and versioning code and data in a collaborative development environment, the system comprising: a versioning database, wherein the versioning database is configured for: storing one or more code objects, wherein each code object comprises one or more code versions; and storing one or more data objects, wherein each data object comprises one or more data versions, wherein each data version comprises a data lineage and a dependency tree, and wherein the data lineage and the dependency tree of each data version comprises information corresponding to a code version of each code object and a data version of each data object used to generate each respective data version; and a server, executing the collaborative development environment, wherein the server is configured for: receiving, from a user, a selection of two or more data versions of a first data object or two or more code versions of a first code object; identifying, between the two or more selected data versions or the two or more selected code versions, resulting changes to one or more data objects and one or more code objects, and visually display said changes to the user; and identifying, between the two or more selected data versions or the two or more selected code versions, a magnitude of impact for each selected data version or each selected code version.
Example 15. The system of Example 14, wherein, a usage metric is tracked for each of the one or more data objects, wherein the usage metric comprises usage information for each of the one or more data versions of the corresponding data object.
Example 16. The system of any one of Examples 14-15, wherein, for any data object run by the user, the user selects a data version to be run, and wherein the selection comprises: selecting, through a user interface, an interface element corresponding to the data version to be run; or specifying, via code, the data version to be run.
Example 17. The system of any one of Examples 14-16, wherein, each data version of a data object and each code version of a code object is selectable, by the user, for consumption; and wherein, when a new version of a data object or a code object is selected by the user, one or more pieces of code are identified as needing to be re-run based on the dependency tree of the new version.
Example 18. The system of any one of Examples 14-17, wherein each data object and code object further comprises: statistics including an identity of one or more consuming users; frequency of consumption; acceptance/rejection by users; and notes corresponding to the acceptance/rejection by users.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A method to comprehensively track and version code and data in a collaborative development environment, the method comprising:
generating, by a user working on a project, a package;
consuming, by the package, one or more component objects, wherein each of the one or more component objects comprises one or more component versions and wherein one of the one or more component versions is selected for consumption;
requesting, by the user, modifications of one or more of the one or more component objects;
generating, by a developer, a new component version for each requested component object modification;
validating, against the package of the requesting user, the new component versions of the component objects;
updating, with their corresponding new component version, each component object;
saving, to a versioning database, each updated component object; and
deploying each of the one or more updated component objects, wherein the consumption of the one or more updated component objects is elective.

2. The method of claim 1, wherein one or more of the one or more updated component objects are consumed by one or more other packages; and
wherein each of the one or more other packages consume an older component version of the updated component objects.

3. The method of claim 1, wherein one or more of the one or more other packages are updated to select, for consumption, the new component version of the one or more updated component objects.

4. The method of claim 1, wherein the new versions of the one or more updated component objects have not been validated against one or more of the one or more other packages.

5. The method of claim 1, wherein, a usage metric is tracked for each of the one or more component objects, wherein the usage metric comprises usage information for each of the one or more component versions of the corresponding component object.

6. The method of claim 1, wherein the new component version of one or more of the updated component objects is executed by the requesting user.

7. A method to comprehensively track and version code and data in a collaborative development environment, the method comprising:
storing, in a versioning database, one or more code objects, wherein each code object comprises one or more code versions;
storing, in the versioning database, one or more data objects, wherein each data object comprises one or more data versions, wherein each data version comprises a data lineage and a dependency tree, and wherein the data lineage and the dependency tree of each data version comprises information corresponding to a code version of each code object and a data version of each data object used to generate each respective data version.

8. The method of claim 7, wherein the collaborative development environment is further configured for:
receiving, from a user, a selection of two or more data versions of a first data object or two or more code versions of a first code object;
identifying, between the two or more selected data versions or the two or more selected code versions, resulting changes to one or more data objects and one or more code objects, and visually display said changes to the user; and
identifying, between the two or more selected data versions or the two or more selected code versions, a magnitude of impact for each selected data version or each selected code version.

9. The method of claim 8, wherein, a usage metric is tracked for each of the one or more data objects, wherein the usage metric comprises usage information for each of the one or more data versions of the corresponding data object.

10. The method of claim 7, wherein, for any data object run by the user, the user selects a data version to be run, and wherein the selection comprises:
selecting, through a user interface, an interface element corresponding to the data version to be run; or
specifying, via code, the data version to be run.

11. The method of claim 10, wherein, each data version of a data object and each code version of a code object is selectable, by the user, for consumption; and
wherein, when a new version of a data object or a code object is selected by the user, one or more pieces of code are identified as needing to be re-run based on the dependency tree of the new version.

12. The method of claim 10, wherein, a usage metric is tracked for each of the one or more data objects, wherein the usage metric comprises usage information for each of the one or more data versions of the corresponding data object.

13. The method of claim 12, wherein each data object and code object further comprises:
statistics including an identity of one or more consuming users;
frequency of consumption;
acceptance/rejection by users; and
notes corresponding to the acceptance/rejection by users.

14. A system for comprehensively tracking and versioning code and data in a collaborative development environment, the system comprising:
a versioning database, wherein the versioning database is configured for:
storing one or more code objects, wherein each code object comprises one or more code versions; and
storing one or more data objects, wherein each data object comprises one or more data versions, wherein each data version comprises a data lineage and a dependency tree, and wherein the data lineage and the dependency tree of each data version comprises information corresponding to a code version of each code object and a data version of each data object used to generate each respective data version; and
a server, executing the collaborative development environment, wherein the server is configured for:
receiving, from a user, a selection of two or more data versions of a first data object or two or more code versions of a first code object;
identifying, between the two or more selected data versions or the two or more selected code versions, resulting changes to one or more data objects and one or more code objects, and visually display said changes to the user; and
identifying, between the two or more selected data versions or the two or more selected code versions, a magnitude of impact for each selected data version or each selected code version.

15. The system of claim 14, wherein, a usage metric is tracked for each of the one or more data objects, wherein the usage metric comprises usage information for each of the one or more data versions of the corresponding data object.

16. The system of claim 15, wherein, for any data object run by the user, the user selects a data version to be run, and wherein the selection comprises:
selecting, through a user interface, an interface element corresponding to the data version to be run; or
specifying, via code, the data version to be run.

17. The system of claim 16, wherein, each data version of a data object and each code version of a code object is selectable, by the user, for consumption; and
wherein, when a new version of a data object or a code object is selected by the user, one or more pieces of code are identified as needing to be re-run based on the dependency tree of the new version.

18. The method of claim 17, wherein each data object and code object further comprises:
statistics including an identity of one or more consuming users;
frequency of consumption;
acceptance/rejection by users; and
notes corresponding to the acceptance/rejection by users.
